(19) United States
(12) Patent Application Publication
(10) Pub. No.: US 2024/0142058 A1
(43) Pub. Date: May 2, 2024

(54) SYSTEMS AND METHODS FOR GAS STORAGE WITH A HEAT MANAGEMENT SYSTEM INCLUDING AN EXPANDER

(71) Applicant: Saudi Arabian Oil Company, Dhahran (SA)

(72) Inventors: Hassan A. Aljama, Qatif (SA); Ali A. Almofleh, Dammam (SA)

(21) Appl. No.: 17/973,673

(22) Filed: Oct. 26, 2022

(51) Int. Cl. F17C 11/00; F17C 13/04

(52) U.S. Cl. CPC F17C 11/007; F17C 13/04; F17C 2205/0323; F17C 2221/033; F17C 2250/0631

(57) ABSTRACT

The disclosure relates to systems and methods for a heat management system in a gas storage system that includes an expander, such as, for example, a sliding vane expander or a pelton expander. The expander can generate work (e.g., electricity) from the pressure drop of a coolant fluid. The work can be used by a compressor in a heat pump.

### FIELD

The disclosure relates to systems and methods for a heat management system in a gas storage system that includes an expander, such as, for example, a sliding vane expander or a pelton expander. The expander can generate work (e.g., electricity) from the pressure drop of a coolant fluid. The work can be used by a compressor in a heat pump.

### BACKGROUND

Often, natural gas production facilities operate optimally at a constant rate of production. However, gas-based power plants usually vary their power production based on the demand. The mismatch between supply and demand typically results in pressure swings in the pipelines that can cause shutdowns in the gas producing facilities and impact the integrity of the natural gas producing wells. When renewable energy sources (e.g., wind, solar) are connected to the electrical grid, the daily swings in sales gas demand can be more significant due to the intermittent nature of the renewable energy sources. Adsorption-based gas storage systems can be used as a buffer to reduce issues related to diurnal swings in daily demand of natural gas in gas-based power plants.

Because the adsorption process is exothermic, the capacity of the adsorption-based storage system is, in general, higher at lower temperatures. Thus, using a heat management system in the adsorption-based storage system can result in a higher adsorption capacity of the storage system due to operating at lower temperature.

### SUMMARY

The disclosure relates to systems and methods for a heat management system in a gas storage system that includes an expander, such as, for example, a sliding vane expander or a pelton expander. The expander can generate work (e.g., electricity) from the pressure drop of a coolant fluid. The work can be used by a compressor in a heat pump. The expanders can be operated with a partially liquefied stream.

Adsorption-based storage systems can store natural gas when there is an excess supply of gas and release the gas when there is excess demand from the gas-based power plant. The systems and method can reduce changes in the gas production rate from gas-producing facilities.

The systems and methods of the disclosure can use a reduced amount of external power for operation relative to certain known gas storage systems and methods. The systems and methods of the disclosure can have higher energy efficiency relative to certain known adsorption-based storage systems and yield capital and operations savings relative to such known gas storage systems and methods.

In a first aspect, the disclosure provides a system, including an adsorption-based natural gas storage unit and a heat pump, including an expander. The heat pump is configured to exchange heat with the adsorption-based natural gas storage unit.

In some embodiments, the heat pump further includes an evaporator, a compressor, a condenser, and a refrigerant fluid configured to circulate between the evaporator, the compressor, the condenser and the expander.

In some embodiments, the expander is configured to produce work from a pressure drop of the refrigerant fluid in the expander.

In some embodiments, the system is configured so that, during use of the system, the work generated by the expander is used by the compressor.

In some embodiments, the system further includes a working fluid configured to exchange heat between the adsorption-based natural gas storage unit and the heat pump.

In some embodiments, the evaporator is configured so that, during use of the system, the evaporator cools working fluid exiting the adsorption-based natural gas storage unit.

In some embodiments, the system includes an adsorption mode wherein cooled working fluid is sent to the adsorption-based natural gas storage unit to remove heat generated from gas adsorption, and a desorption mode wherein heated working fluid is sent to the adsorption-based natural gas storage unit to release adsorbed gas.

In some embodiments, the system further includes a chiller configured to cool the working fluid prior to sending the working fluid to the adsorption-based natural gas storage unit during the adsorption mode.

In some embodiments, the system further includes an auxiliary heater configured to heat the working fluid prior to sending the working fluid to the heat pump during the desorption mode.

In some embodiments, the system further includes a first storage tank configured to store cooled working fluid.

In some embodiments, the system further includes a second storage tank configured to store heated working fluid.

In some embodiments, the expander includes a sliding vane expander.

In some embodiments, the expander includes a pelton expander.

In some embodiments, the system further includes a natural gas source. The adsorption-based natural gas storage unit includes an inlet including a valve. In a first position, the valve permits fluid communication between the adsorption-based natural gas storage unit and the natural gas source. In a second position, the valve prohibits fluid communication between the adsorption-based natural gas storage unit and the natural gas source.

In some embodiments, the system further includes a gas-based power plant. The adsorption-based natural gas storage unit includes an outlet including a valve. In a first position, the valve permits fluid communication between the adsorption-based natural gas storage unit and the gas-based power plant. In a second position, the valve prohibits fluid communication between the adsorption-based natural gas storage unit and the gas-based power plant.

In a second aspect, the disclosure provides a method of operating a system including an adsorption-based natural gas storage unit, a working fluid and a heat pump, the heat pump including an expander. The method includes using the heat pump to exchange heat with the adsorption-based natural gas storage unit.

In certain embodiments, the heat pump further includes a compressor and a refrigerant fluid.

In certain embodiments, the method further includes producing work from the expander due to a pressure drop of the refrigerant fluid in the expander.

In certain embodiments, the work generated by the expander is used by the compressor.

In a third aspect, the disclosure provides a method, including: circulating a refrigerant fluid between an evaporator, a compressor, a condenser and an expander of a heat pump;

generating work from a pressure drop of the refrigerant fluid in the expander; using the work generated in the expander to power the compressor; heating a working fluid using the condenser; and passing heated working fluid to an adsorption-based natural gas storage unit.

### BRIEF DESCRIPTION OF THE FIGURES

FIG. 1 depicts a schematic view of a system.

FIG. 2A depicts a schematic side view of a system.

FIG. 2B depicts a schematic front view of the system in FIG. 2A.

FIG. 2C depicts a schematic view of a portion of the system in FIG. 2B.

FIG. 3A depicts a schematic view of a system.

FIG. 3B depicts a schematic view of a portion of the system in FIG. 3A.

FIG. 4 depicts a schematic of a system used in a simulation.

FIG. 5 depicts a schematic of a system used in a simulation.

### DETAILED DESCRIPTION

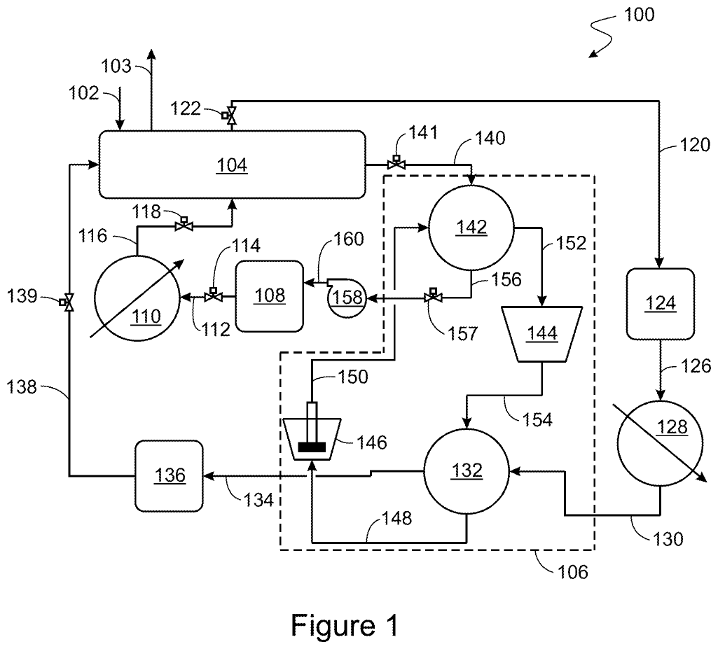

FIG. 1 shows a process flow diagram of a system 100 for thermal storage and heat exchange during adsorption and desorption cycles, for example for natural gas adsorption and desorption. In the thermal energy storage and heat exchange adsorption system 100, a compressed gas line 102 feeds compressed gas under pressure to a gas adsorption skid 104 comprising adsorbent material to adsorb gas. In some embodiments, the compressed gas line is in fluid communication with a natural gas source (e.g., a natural gas producing well). In some embodiments, the compressed gas line 102 includes a valve such that when the valve is open, the gas adsorption skid 104 is in fluid communication with the natural gas source and when the valve is closed, the gas adsorption skid 104 is not in fluid communication with the natural gas source. In some embodiments, the gas includes natural gas such as methane. In some embodiments, the gas includes carbon dioxide. Adsorbent materials can include activated carbons, zeolites, metal organic frameworks (MOF's), polymers, and/or any other suitable adsorbent materials for adsorbing compressed gas. A compressed gas line 103 is configured to remove desorbed gas from the gas adsorption skid 104. In some embodiments, the compressed gas line 103 is in fluid communication with a gas-based power plant. In some embodiments, the compressed gas line 103 includes a valve such that when the valve is open, the gas adsorption skid 104 is in fluid communication with the gas-based power plant and when the valve is closed, the gas adsorption skid 104 is not in fluid communication with the gas-based power plant.

The gas adsorption skid 104 contains two adsorption beds loaded with microporous material. One description of how gas is introduced to and removed from such a unit or multiple units is found in U.S. Pat. No. 9,562,649. Generally, a temperature modifying fluid (working fluid) is introduced to the gas adsorption skid 104 at a low temperature to absorb and remove heat released during the adsorption stage via indirect heat transfer. The working fluid is then stored to be used later during the desorption stage to supply needed energy (heat) to facilitate gas release from the adsorption bed. A heat pump 106, indicated by a dashed line in FIG. 1, is used to exchange energy between separate working fluid and refrigerant streams.

During an adsorption stage where a gas such as natural gas is introduced to the gas adsorption skid 104 via the compressed gas line 102, a working fluid, initially stored in a tank 108 at low temperature conditions passes to a chiller 110, such as for example an air cooled chiller, via a line 112 with a control valve 114 to reduce its temperature to an appropriate value. Tank 108 and other tanks described and the line 112 along with other lines described can be thoroughly insulated to prevent heat or cooling losses. The chiller 110, and other units described requiring power, can be operated by either or both burning some of the stored gas or using excess solar energy, or other renewable sources such as wind, produced during peak radiation periods or wind periods when the storage facility is used for solar-based power plants or wind-based power plants.

Chilled working fluid, which can include either or both of liquid or gas refrigerant or water, then flows to the gas adsorption skid 104 via a chilled fluid line 116 with a control valve 118. After passing through coils inside adsorption beds (not pictured) of the gas adsorption skid 104 for indirect heat transfer, the chilled working fluid leaves the gas adsorption skid 104 via a line 120 with a control valve 122 to fill an insulated tank 124 at a temperature slightly lower than that of the adsorption beds of the gas adsorption skid 104. During adsorption of gas such as natural gas, the chilled working fluid absorbs heat from the gas adsorption skid 104, increasing its temperature. In some embodiments, the tank 108 and/or the tank 124 is thermally insulated to minimize heat leakage to and from the tank 108 and/or the tank 124. The chiller 110 is used to reject input energy to operate the heat pump 106 and is optionally used to compensate for heat leakage into the tank 108 from the environment that tends to increase the temperature of the working fluid.

During a desorption stage, working fluid stored in the tank 124 is supplied to the gas adsorption skid 104. First, the working fluid passes via a line 126 to an auxiliary heater 128. The auxiliary heater 128 compensates for any heat losses from the tank 124. Next, the working fluid proceeds via a line 130 to a condenser 132 to increase the working fluid's temperature to an appropriate selected target value (for heating adsorbent materials for gas release in the gas adsorption skid 104). Then, the working fluid proceeds via a line 134 to an auxiliary tank 136. The auxiliary tank 136 is used to initiate the desorption stage. In some embodiments, the auxiliary heater 128 includes an electric heater, and its duty depends at least in part on the heat loss rate in the tank 124. In some embodiments, the condenser 132 includes a shell and tube heat exchanger in which the working fluid passes through the shell side while a refrigerant at high temperature conditions passes through the tube side. The volume of the auxiliary tank 136 depends in part on the volume of pipe connections between the auxiliary tank 136 and the tank 108. Ultimately, heated working fluid at a target increased temperature passes to the gas adsorption skid 104 via a line 138 with a control valve 139 for release of gas, such as natural gas, from adsorbent materials.

The use of the auxiliary tank 136 is optional to ensure proper fluid temperature entering the gas adsorption skid 104 at the startup of the desorption cycle. The fluid temperature at the tank 124 is not suitable to pass through the adsorption skid during the desorption process. In some embodiments, the auxiliary heater 128 is used to increase the temperature of the fluid to a target temperature that is suitable to heat up the adsorption bed at the startup of the desorption cycle and the auxiliary tank 136 is not needed.

Inside the heat pump 106, a refrigerant fluid is circulated to exchange energy/heat between working fluid exiting the gas adsorption skid 104 in a line 140 with a control valve 141 during a desorption cycle and working fluid from a line 130 entering a condenser 132. The heat pump includes an evaporator 142, a compressor 144, the condenser 132, and an expander 146 (e.g., a shaft work expander). The heat pump 106 operates to exchange heat as refrigerant fluid is recirculated between the condenser 132, the expander 146, the evaporator 142, and the compressor 144 via the streams 148, 150, 152, and 154. The expander 146 produces work from the pressure drop of the coolant fluid and the work is used by the compressor 144 in the heat pump 106. Once working fluid exiting the gas adsorption skid 104 in the line 140 during a desorption cycle passes through the evaporator 142, indirectly removing more heat from the working fluid to the refrigerant, the working fluid passes to a pump 158 via the line 156 with a control valve 157, and then to the tank 108 via a line 160 to be used as a chilled working fluid during an adsorption cycle for heat removal from gas adsorption skid 104.

Without wishing to be bound by theory, it is believed, that the expander 146 reduces the pressure of the stream 148 and recovers some of the energy lost as a result of the pressure drop. The generator in the expander 146 converts the kinetic energy from pressure drop of the coolant fluid into energy used to supply power to the compressor 144. In some embodiments, the feed to the expander 146 is a two-phase fluid. In some embodiments, the expander 146 can work with a two-phase inlet stream. In some embodiments, the refrigerant (working fluid) leaves the condenser 132 as a saturated liquid before it is expanded to a two-phase mixture in the expander 146.

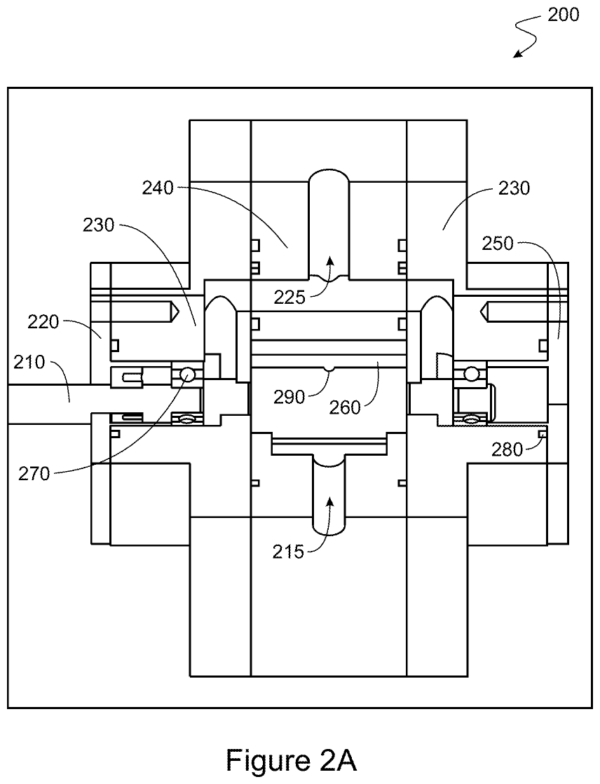

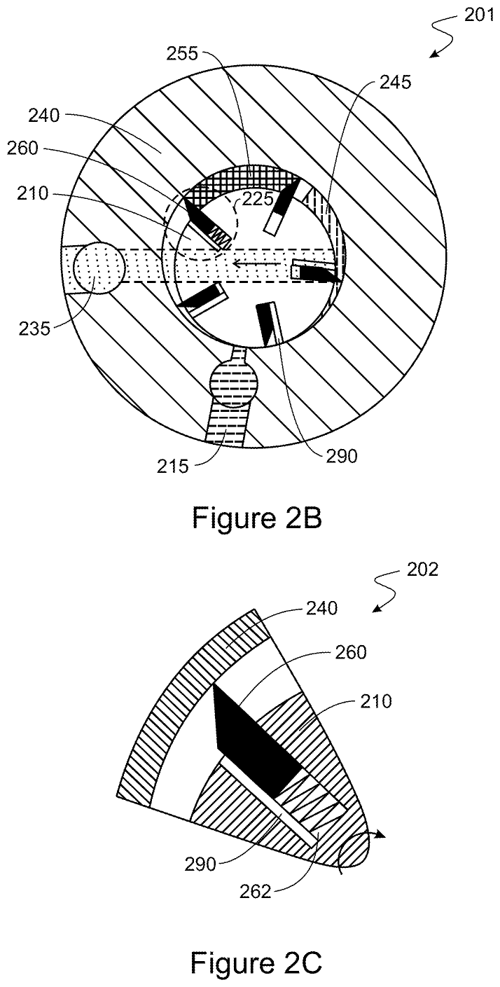

In some embodiments, the expander 146 is a sliding vane expander. FIG. 2A shows a schematic for a side view of a sliding vane expander 200, FIG. 2B shows a schematic for a front view of a portion 201 the sliding vane expander 200 and FIG. 2C shows a portion 202 of the sliding vane expander 200 portion 201 shown in FIG. 2B. The sliding vane expander 200 includes a rotor 210, a suction channel 215, a left end cap 220, a discharge channel 225, a bearing chock 230, a discharge port 235, a cylinder 240, a discharge chamber 245, a right end cap 250, an expansion chamber 255, vanes 260, a bearing 270, a sealing grove 280, and a back-pressure groove 290. Each vane 260 includes a spring 262.

Circulating refrigerant causes rotation of the rotor 210. As the rotor 210 rotates, the springs 262 cause the vanes 260 to extend and retract to maintain contact with the wall of the cylinder 240. The vanes 260 create the discharge chamber 245 and the expansion chamber 255 within the cylinder 240 of varying sizes. Air enters at the expansion chamber 255 via the suction channel 215. As the vanes 260 rotate, they retract causing the expansion chamber 255 to get smaller and to compress the air. After that, air exits at the discharge chamber 245 via the discharge channel 225.

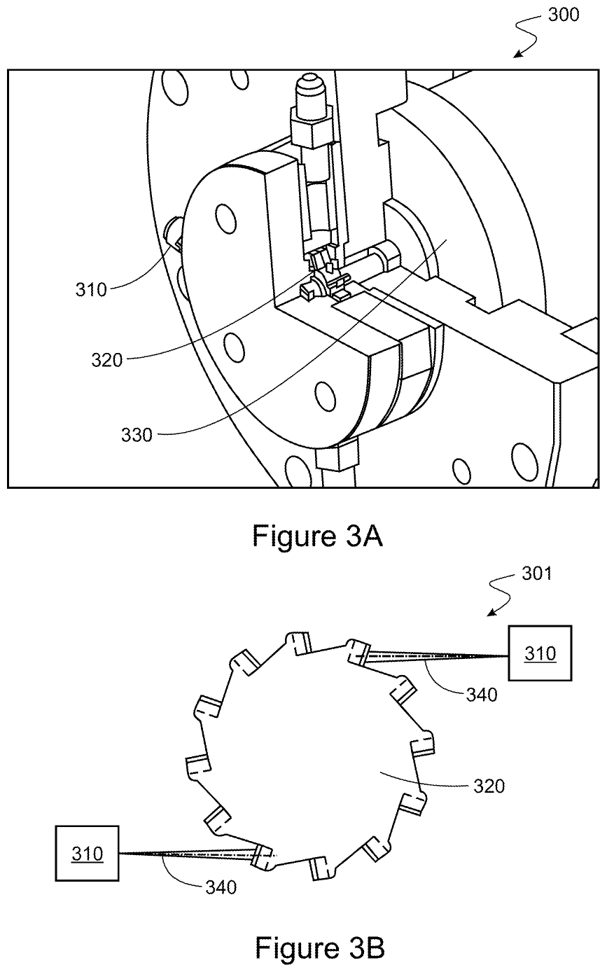

In some embodiments, the expander 146 is a pelton expander. FIG. 3A shows a schematic for a pelton expander 300, and FIG. 3B shows a schematic for a portion 301 of the pelton expander 300. The pelton expander 300 includes a nozzle 310, an impeller 320 and a generator 330. After entering the nozzle 310, the refrigerant 340 exits the nozzle 310 and hits the impellers 320, which induces an impulsive force. This force makes the generator 330 rotate. The impellers 320 runs the generator 330 and produces electricity.

The isentropic efficiency (n_{isentropic}) of the expander 146 can be calculated using the equation:

$${η}_{i s e n t r o p i c} = \frac{{h}_{1} - {h}_{2 , a}}{{h}_{1} - {h}_{2 , s}} \qquad ( 1 )$$

where (h₁) is the enthalpy of the stream 148 entering the expander 146, and (h₂) is the enthalpy of the stream 150 leaving the expander 146 in the expansion process. The subscript (a) indicates the actual enthalpy and subscript (s) indicates the isentropic enthalpy.

The isentropic enthalpy in equation 1 (h_{2,s}) can be obtained from a standard thermodynamic table (based on pressure and the entropy, which are assumed to be equal to the entropy of the stream 148). In some embodiments, the expander 146 works with an isentropic efficiency of at least 16 (e.g., at least 18, at least 20, at least 22, at least 24, at least 26, at least 28, at least 30) % and/or at most 32 (e.g., at most 30, at most 28, at most 26, at most 24, at most 22, at most 20, at most 18) %. The expander 146 can work with an isentropic efficiency of 32% at the optimum operating conditions.

The Coefficient of Performance (COP) for the system 100 is calculated using the equation:

$$C O P = \frac{{Q}_{c o n d}}{W} \qquad ( 2 )$$

where Q_{cond} is the condenser duty and W is the compressor duty (see table 5 below). The COP can provide a measure of the efficiency of the system 100 and enable the comparison between the system 100 and other systems (see table 3 below). In some embodiments, the COP of the system 100 is increased by at least 1 (e.g., at least 2, at least 3, at least 4, at least 5, at least 6, at least 7, at least 8, at least 9) % and/or at most 10 (e.g., at most 9, at most 8, at most 7, at most 6, at most 5, at most 4, at most 3, at most 2) % relative to a system identical to the system 100 except that a throttling valve is used instead of the expander 146.

In certain embodiments, a vapor fraction of the refrigerant fluid is at least 0 (e.g., at least 0.1, at least 0.2, at least 0.3, at least 0.4, at least 0.5, at least 0.6, at least 0.7, at least 0.8, at least 0.9) and/or at most 1 (e.g., at most 0.9, at most 0.8, at most 0.7, at most 0.6, at most 0.5, at most 0.4, at most 0.3, at most 0.2, at most 0.1) prior to entering the expander 146 and/or at least 0 (e.g., at least 0.1, at least 0.2, at least 0.3, at least 0.4, at least 0.5, at least 0.6, at least 0.7, at least 0.8, at least 0.9) and/or at most 1 (e.g., at most 0.9, at most 0.8, at most 0.7, at most 0.6, at most 0.5, at most 0.4, at most 0.3, at most 0.2, at most 0.1) after exiting the expander 146. In certain embodiments, a temperature of the refrigerant fluid is at least 55 (e.g., at least 60, at least 65, at least 70) ° C. and/or at most 75 (e.g., at most 70, at most 65, at most 60) ° C. prior to entering the expander 146 and/or at least −5 (e.g., at least 0, at least 5, at least 10) ° C. and/or at most 15 (e.g., at most 10, at most 5, at most 0) ° C. after exiting the expander 146. In certain embodiments, a pressure of the refrigerant fluid is at least 15 (e.g., at least 16, at least 17, at least 18, at least 19, at least 20, at least 21) bar and/or at most 22 (e.g., at most 21, at most 20, at most 19, at most 18, at most 17, at most 16) prior to entering the expander 146 and/or at least 1 (e.g., at least 2, at least 3, at least 4, at least 5) bar and/or at most 6 (e.g., at most 5, at most 4, at most 3, at most 2) bar after exiting the expander 146. In certain embodiments, a molar flow of the refrigerant fluid is at least 40 (e.g., at least 45, at least 50, at least 55, at least 60, at least 65) kgmole/h and/or at most 70 (e.g., at most 65, at most 60, at most 55, at most 50, at most 45) kgmole/h prior to entering the expander 146 and/or at least 40 (e.g., at least 45, at least 50, at least 55, at least 60, at least 65) kgmole/h and/or at most 70 (e.g., at most 65, at most 60, at most 55, at most 50, at most 45) kgmole/h after exiting the expander 146. In certain embodiments, a mass flow of the refrigerant fluid is at least 1.0 (e.g., at least 1.1, at least 1.2, at least 1.3, at least 1.4, at least 1.5, at least 1.6, at least 1.7, at least 1.8, at least 1.9) kg/s and/or at most 2.0 (e.g., at most 1.9, at most 1.8, at most 1.7, at most 1.6, at most 1.5, at most 1.4, at most 1.3, at most 1.2, at most 1.1) kg/s prior to entering the expander 146 and/or at least 1.0 (e.g., at least 1.1, at least 1.2, at least 1.3, at least 1.4, at least 1.5, at least 1.6, at least 1.7, at least 1.8, at least 1.9) kg/s and/or at most 2.0 (e.g., at most 1.9, at most 1.8, at most 1.7, at most 1.6, at most 1.5, at most 1.4, at most 1.3, at most 1.2, at most 1.1) kg/s after exiting the expander 146. In certain embodiments, a liquid volume flow of the refrigerant fluid is at least 3.5 (e.g., at least 4, at least 4.5, at least 5) m³/h and/or at most 5.5 (e.g., at most 5, at most 4.5, at most 4) m³/h prior to entering the expander 146 and/or at least 3.5 (e.g., at least 4, at least 4.5, at least 5) m³/h and/or at most 5.5 (e.g., at most 5, at most 4.5, at most 4) m³/h after exiting the expander 146. In certain embodiments, a heat flow of the refrigerant fluid is at least −6×10⁷ (e.g., at least −5.5×10⁷, at least −5×10⁷, at least −4.5×10⁷) kJ/h and/or at most −4×10⁷ (e.g., at most −4.5×10⁷, at most −5×10⁷, at most −5.5×10⁷) kJ/h prior to entering the expander 146 and/or at least −6×10⁷ (e.g., at least −5.5×10⁷, at least −5×10⁷, −4.5×10⁷) kJ/h and/or at most −4×10⁷ (e.g., at most −4.5×10⁷, at most −5×10⁷, −5.5×10⁷) kJ/h after exiting the expander 146.

### Example

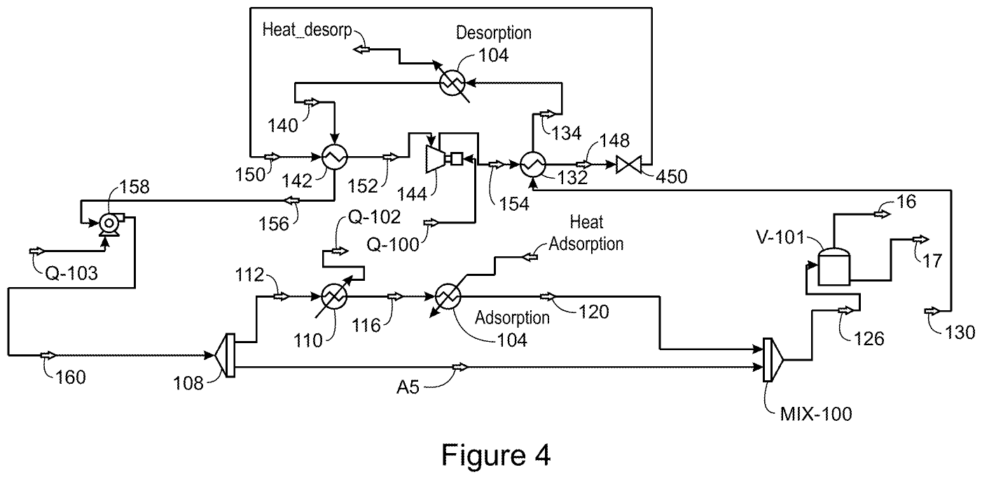

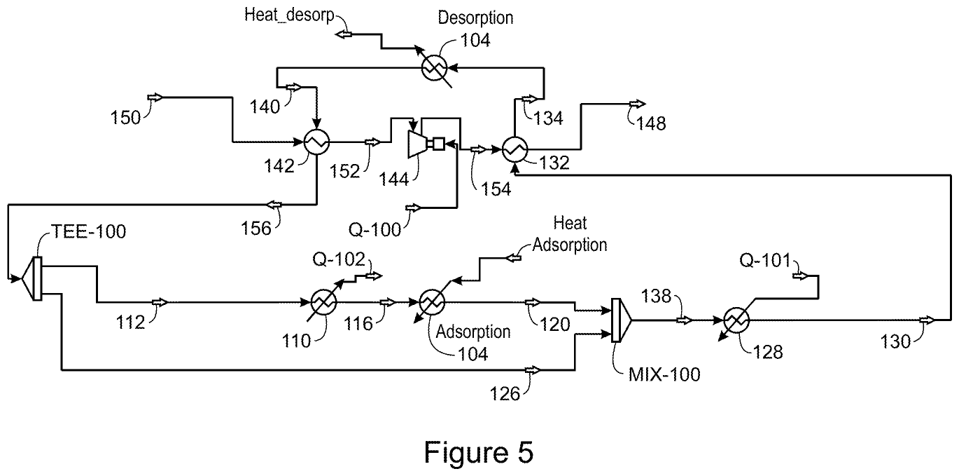

Simulations were performed using HYSYS in order to compare the overall energy consumption of a system with a throttling valve instead of the expander 146 and system with the expander 146 and no throttling valve (as depicted in FIG. 1). The systems used in the simulations are schematically depicted in FIGS. 4 and 5, respectively. FIG. 4 includes a throttling valve 450, whereas FIG. 5 includes the expander 146. The results of the simulations are presented in tables 3-5.

Equation 1 was used to calculate the enthalpy of the stream 150 (h_{2,a}) as −5.048×10⁷ kJ/hr, using an entropic efficiency of 32%, which was used in the HYSYS model.

FIG. 4 is a snapshot of the HYSYS flowsheet case used to simulate the operation of the system with a throttling valve 450 and without an expander. Q-100, Q-101 and Q-103 are the energy inputs to operate each unit and Q-102 is the energy generated from the condenser. V-101 is an isolation tank to store energy and streams 16 and 17 are the output streams. Energy storage can only be performed during the adsorption cycle. MIX-100 is a mixer and P-100 is the pump 158. The line 160 is divided into two lines 112 and A5, both are equal in flow rate. FIG. 5 is a snapshot of the HYSYS flowsheet case used to simulate the operation of the system with an expander 146 and without a throttling valve 450. Since HYSYS does not support the use of an expander with two-phase inlet stream, the energy generated by the expander was calculated by manually taking the difference in heat flows of streams 150 and 148, where the heat flows were obtained from HYSYS by specifying the pressure, temperature and flow rate of the stream in HYSYS. Streams 152, 154, 148 and 150 represent the refrigeration cycle. Stream 148 feeds the expander 146 (not depicted as HYSYS does not support multi-phase expander). The stream 150 is the stream coming from the expander 146. TEE-100 is a splitter and MIX-100 is a mixer. Tables 1 and 2 show the properties calculated from HYSYS for each stream of the systems in FIGS. 4 and 5, respectively.

TABLE 1

| Stream | 150 | 152 | 140 | 156 | 154 | 148 | 130 | 134 |
|---|---|---|---|---|---|---|---|---|
| Vapor | 0.4736 | 1.0000 | 0.0000 | 0.0000 | 1.0000 | 0.0000 | 0.0000 | 0.0000 |
| Fraction | | | | | | | | |
| Temperature | 5.001 | 5.000 | 36.71 | 10.62 | 80.32 | 65.00 | 22.10 | 60.00 |
| (° C.) | | | | | | | | |
| Pressure | 3.484 | 3.484 | 1.200 | 1.100 | 19.08 | 18.98 | 1.400 | 1.300 |
| (bar) | | | | | | | | |
| Molar | 65.27 | 65.27 | 342.1 | 342.1 | 65.27 | 65.27 | 342.1 | 342.1 |
| Flow | | | | | | | | |
| (kgmole/ | | | | | | | | |
| h) | | | | | | | | |
| Mass | 1.850 | 1.850 | 1.712 | 1.712 | 1.850 | 1.850 | 1.712 | 1.712 |
| Flow | | | | | | | | |
| (kg/s) | | | | | | | | |
| Liquid | 5.361 | 5.361 | 6.176 | 6.176 | 5.361 | 5.361 | 6.176 | 6.176 |
| Volume | | | | | | | | |
| Flow | | | | | | | | |
| (m³/h) | | | | | | | | |
| Heat | −5.931 × 10⁷ | −5.861 × 10⁷ | −9.761 × 10⁷ | −9.830 × 10⁷ | −5.830 × 10⁷ | −5.931 × 10⁷ | −9.800 × 10⁷ | −9.699 × 10⁷ |
| Flow | | | | | | | | |
| (kJ/h) | | | | | | | | |
| Stream | 112 | 116 | 120 | 160 | A5 | 126 | 16 | 17 |
| Vapor | 0.0000 | 0.0000 | 0.0000 | 0.0000 | 0.0000 | 0.0000 | 1.0000 | 0.0000 |
| Fraction | | | | | | | | |
| Temperature | 10.62 | 20.00 | 34.48 | 10.62 | 10.62 | 29.84 | 29.84 | 29.84 |
| (° C.) | | | | | | | | |
| Pressure | 1.600 | 1.500 | 1.400 | 1.600 | 1.600 | 1.400 | 1.400 | 1.400 |
| (bar) | | | | | | | | |
| Molar | 275.6 | 275.6 | 275.6 | 342.1 | 66.52 | 342.1 | 0.0000 | 342.1 |
| Flow | | | | | | | | |
| (kgmole/ | | | | | | | | |
| h) | | | | | | | | |
| Mass | 1.379 | 1.379 | 1.379 | 1.712 | 0.3329 | 1.712 | 0.0000 | 1.712 |
| Flow | | | | | | | | |
| (kg/s) | | | | | | | | |
| Liquid | 4.975 | 4.975 | 4.975 | 6.176 | 1.201 | 6.176 | 0.0000 | 6.176 |
| Volume | | | | | | | | |
| Flow | | | | | | | | |
| (m³/h) | | | | | | | | |
| Heat | −7.919 × 10⁷ | −7.899 × 10⁷ | −7.868 × 10⁷ | −9.830 × 10⁷ | −1.911 × 10⁷ | −9.779 × 10⁷ | 0.0000 | −9.779 × 10⁷ |
| Flow | | | | | | | | |
| (kJ/h) | | | | | | | | |

TABLE 2

| Stream | 150 | 152 | 140 | 156 | 154 | 148 | 130 |
|---|---|---|---|---|---|---|---|
| Vapor | 0.4565 | 1.0000 | 0.0000 | 0.0000 | 1.0000 | 0.0000 | 0.0000 |
| Fraction | | | | | | | |
| Temperature | 5.002 | 5.000 | 41.09 | 22.47 | 80.32 | 65.00 | 33.82 |
| (° C.) | | | | | | | |
| Pressure | 3.484 | 3.484 | 1.200 | 1.100 | 19.08 | 18.98 | 1.400 |
| (bar) | | | | | | | |
| Molar | 55.54 | 55.54 | 421.2 | 421.2 | 55.54 | 55.54 | 421.2 |
| Flow | | | | | | | |
| (kgmole/h) | | | | | | | |
| Mass | 1.574 | 1.574 | 2.108 | 2.108 | 1.574 | 1.574 | 2.108 |
| Flow | | | | | | | |
| (kg/s) | | | | | | | |
| Liquid | 4.561 | 4.561 | 7.604 | 7.604 | 4.561 | 4.561 | 7.604 |
| Volume | | | | | | | |
| Flow | | | | | | | |
| (m³/h) | | | | | | | |
| Heat Flow | −5.048 × 10⁷ | −4.97 × 10⁷ | −1.200 × 10⁷ | −1.207 × 10⁷ | −4.961 × 10⁷ | −5.046 × 10⁷ | −1.203 × 10⁷ |
| (kJ/h) | | | | | | | |

| Stream | 134 | 112 | 116 | 120 | 126 | 138 |
|---|---|---|---|---|---|---|
| Vapor | 0.0000 | 0.0000 | 0.0000 | 0.0000 | 0.0000 | 0.0000 |
| Fraction | | | | | | |
| Temperature | 60.00 | 22.47 | 14.87 | 33.82 | 22.47 | 28.15 |
| (° C.) | | | | | | |
| Pressure | 1.300 | 1.100 | 1.000 | 0.9000 | 1.100 | 0.9000 |
| (bar) | | | | | | |
| Molar | 421.2 | 210.6 | 210.6 | 210.6 | 210.7 | 421.2 |
| Flow | | | | | | |
| (kgmole/h) | | | | | | |
| Mass | 2.108 | 1.054 | 1.054 | 1.054 | 1.054 | 2.108 |
| Flow | | | | | | |
| (kg/s) | | | | | | |
| Liquid | 7.604 | 3.801 | 3.801 | 3.801 | 3.803 | 7.604 |
| Volume | | | | | | |
| Flow | | | | | | |
| (m³/h) | | | | | | |
| Heat Flow | −1.194 × 10⁷ | −6.031 × 10⁷ | −6.044 × 10⁷ | −6.013 × 10⁷ | −6.034 × 10⁷ | −1.205 × 10⁷ |
| (kJ/h) | | | | | | |

The Coefficient of Performance (COP) was calculated using Equation 2, using compressor duties obtained from HYSYS simulations, as shown in Table 5. In the heat management system in FIG. 4 with the throttling valve 450, the main source of energy consumption was the compressor, which required approximately 74 kW. Because the desorption process was being simulated, the cycle was working as a heat pump system. Therefore, the condenser duty was used in the equation to calculate COP.

The first column in Table 3 shows the COP of the system in FIG. 4. The second column in Table 3 shows the COP of the system in FIG. 5. The third column in Table 3 shows the percentage improvement in the COP for the system in FIG. 5 compared with the system in FIG. 4. In particular, Table 3 shows that the COP of the system of FIG. 5 (including the expander 146) was improved by 8% relative to the system of FIG. 4 (including the throttling valve 450).

$$C O P ( improvement ) \% = \frac{C O P ( expander system ) - C O P ( throttling valve system )}{C O P ( expander system )} \times 100$$

TABLE 3

| | | % Improvement due to |
|---|---|---|
| COP (throttling | COP (expander | replacing the throttling |
| valve system) | system) | valve with an expander |
| 3.2 | 3.5 | 8 |

Table 4 shows the pressures and temperatures of the system of FIG. 4 (with the throttling valve 450) and the system of FIG. 5 (with the expander 146) calculated from HYSYS. Table 4 shows that the pressure and temperature of each stream is almost the same before and after using the expander 146. Table 5 shows the required duties of the system of FIG. 4 (with the throttling valve 450) and the system of FIG. 5 (with the expander 146), based on HYSYS simulations. As shown in Table 5, the required duty of the chiller 110, auxiliary heater 128 and compressor 144 changed. The overall required energy decreased by 19,130 kJ/hr (3.3% reduction), and the compressor duty was reduced by 7.2%.

TABLE 4

| | |
|---|---|
| FIG. 4 | FIG. 5 |

| Stream # | P [bar] | T [C.] | P [bar] | T [C.] |
|---|---|---|---|---|
| 112 | 1.10 | 23.06 | 1.10 | 22.47 |
| 116 | 1.00 | 14.87 | 1.00 | 14.87 |
| 120 | 0.90 | 33.82 | 0.90 | 33.82 |
| 126 | 1.10 | 23.06 | 1.10 | 22.47 |
| 130 | 1.40 | 33.82 | 1.40 | 33.82 |
| 134 | 1.30 | 60.00 | 1.30 | 60.00 |
| 138 | 0.90 | 28.44 | 0.90 | 28.15 |
| 140 | 1.20 | 41.09 | 1.20 | 41.09 |
| 156 | 1.10 | 23.06 | 1.10 | 22.47 |
| 160 | 3.48 | 5.00 | 3.48 | 5.00 |
| 154 | 19.08 | 80.32 | 19.08 | 80.32 |
| 148 | 18.98 | 65.00 | 18.98 | 65.00 |
| 150 | 3.48 | 5.00 | 3.48 | 5.00 |

TABLE 5

| | Original | New |
|---|---|---|
| Equipment | Duty [kJ/h] | Duty [kJ/h] |
| Chiller 110 | 134,100 | 124,500 |
| Heater 128 | 176,400 | 186,100 |
| Compressor 144 | 267,800 | 248,570 |
| Total | 578,300 | 559,170 |

### Other Embodiments

While certain embodiments have been disclosed above, the disclosure is not limited to such embodiments.

As an example, while embodiments have been disclosed that include the components of the thermal energy storage and heat exchange adsorption system 100 depicted in FIG. 1, the disclosure is not limited to such embodiments. For example, the thermal energy storage and heat exchange adsorption system 100 can contain one or more additional components not depicted. Additionally, or alternatively, the thermal energy storage and heat exchange adsorption system 100 may not contain each component depicted. Further, components of the system 100 may be reconfigured as appropriate.

What is claimed:

1. A system, comprising:
an adsorption-based natural gas storage unit; and
a heat pump, comprising an expander,
wherein the heat pump is configured to exchange heat with the adsorption-based natural gas storage unit.

2. The system of claim 1, wherein the heat pump further comprises:
an evaporator;
a compressor;
a condenser; and
a refrigerant fluid configured to circulate between the evaporator, the compressor, the condenser and the expander.

3. The system of claim 2, wherein the expander is configured to produce work from a pressure drop of the refrigerant fluid in the expander.

4. The system of claim 3, wherein the system is configured so that, during use of the system, the work generated by the expander is used by the compressor.

5. The system of claim 2, further comprising a working fluid configured to exchange heat between the adsorption-based natural gas storage unit and the heat pump.

6. The system of claim 5, wherein the evaporator is configured so that, during use of the system, the evaporator cools working fluid exiting the adsorption-based natural gas storage unit.

7. The system of claim 5, wherein the system comprises:
an adsorption mode wherein cooled working fluid is sent to the adsorption-based natural gas storage unit to remove heat generated from gas adsorption; and
a desorption mode wherein heated working fluid is sent to the adsorption-based natural gas storage unit to release adsorbed gas.

8. The system of claim 7, further comprising a chiller configured to cool the working fluid prior to sending the working fluid to the adsorption-based natural gas storage unit during the adsorption mode.

9. The system of claim 7, further comprising an auxiliary heater configured to heat the working fluid prior to sending the working fluid to the heat pump during the desorption mode.

10. The system of claim 7, further comprising a first storage tank configured to store cooled working fluid.

11. The system of claim 10, further comprising a second storage tank configured to store heated working fluid.

12. The system of claim 1, wherein the expander comprises a sliding vane expander.

13. The system of claim 1, wherein the expander comprises a pelton expander.

14. The system of claim 1, further comprising a natural gas source, wherein:
the adsorption-based natural gas storage unit comprises an inlet comprising a valve;
in a first position, the valve permits fluid communication between the adsorption-based natural gas storage unit and the natural gas source; and
in a second position, the valve prohibits fluid communication between the adsorption-based natural gas storage unit and the natural gas source.

15. The system of claim 1, further comprising a gas-based power plant, wherein:
the adsorption-based natural gas storage unit comprises an outlet comprising a valve;
in a first position, the valve permits fluid communication between the adsorption-based natural gas storage unit and the gas-based power plant; and
in a second position, the valve prohibits fluid communication between the adsorption-based natural gas storage unit and the gas-based power plant.

16. A method of operating a system comprising an adsorption-based natural gas storage unit, a working fluid and a heat pump, the heat pump comprising an expander, the method comprising:
using the heat pump to exchange heat with the adsorption-based natural gas storage unit.

17. The method of claim 16, wherein the heat pump further comprises a compressor and a refrigerant fluid.

18. The method of claim 17, further comprising producing work from the expander due to a pressure drop of the refrigerant fluid in the expander.

19. The method of claim 18, wherein the work generated by the expander is used by the compressor.

20. A method, comprising:
circulating a refrigerant fluid between an evaporator, a compressor, a condenser and an expander of a heat pump;
generating work from a pressure drop of the refrigerant fluid in the expander;
using the work generated in the expander to power the compressor;
heating a working fluid using the condenser; and
passing heated working fluid to an adsorption-based natural gas storage unit.
